(19) United States
(12) Patent Application Publication
(10) Pub. No.: US 2025/0364180 A1
(43) Pub. Date: Nov. 27, 2025

(54) MULTILAYER CERAMIC CAPACITOR

(71) Applicant: Murata Manufacturing Co., Ltd., Nagaokakyo-shi (JP)

(72) Inventors: Takashi OHARA, Nagaokakyo-shi (JP); Hideyasu ONISHI, Nagaokakyo-shi (JP); Kota KUMAKURA, Nagaokakyo-shi (JP)

(21) Appl. No.: 19/293,646

(22) Filed: Aug. 7, 2025

Related U.S. Application Data
(63) Continuation of application No. PCT/JP2024/003420, filed on Feb. 2, 2024.

(30) Foreign Application Priority Data
Feb. 27, 2023 (JP) 2023-028471

(51) Int. Cl. H01G 4/008; H01G 4/012; H01G 4/12; H01G 4/30

(52) U.S. Cl. CPC H01G 4/008; H01G 4/012; H01G 4/1227; H01G 4/30

(57) ABSTRACT

A multilayer ceramic capacitor includes a multilayer body including ceramic dielectric layers stacked together and inner electrodes extending along interfaces between the dielectric layers. The inner electrodes include a conductive component including X and a ceramic component including XTiO₃, where X represents a conductive metal or an alloy including a conductive metal.

### CROSS REFERENCE TO RELATED APPLICATIONS

This application claims the benefit of priority to Japanese Patent Application No. 2023-028471 filed on Feb. 27, 2023 and is a Continuation Application of PCT Application No. PCT/JP2024/003420 filed on Feb. 2, 2024. The entire contents of each application are hereby incorporated herein by reference.

### BACKGROUND OF THE INVENTION

### 1. Field of the Invention

The present disclosure relates to multilayer ceramic capacitors, and particularly to a composition of inner electrodes included in multilayer ceramic capacitors.

### 2. Description of the Related Art

A multilayer ceramic capacitor typically includes a multilayer body having multiple ceramic dielectric layers stacked together and multiple inner electrodes arranged along multiple interfaces between the dielectric layers, with each inner electrode along a respective interface, and multiple outer electrodes provided at the outer surface of the multilayer body and electrically coupled to the inner electrodes. The inner electrodes include multiple first inner electrodes and multiple second inner electrodes arranged alternately in the direction of stacking in the multilayer body, and the outer electrodes include a first outer electrode electrically coupled to the first inner electrodes and a second outer electrode electrically coupled to the second inner electrodes.

To reduce the size and increase the capacitance of a multilayer ceramic capacitor in such a structure simultaneously, it is required to form the dielectric layers and inner electrodes as thin layers while increasing the coverage of the inner electrodes (electrode continuity). In general, in the firing step during the manufacture of a multilayer ceramic capacitor, the temperature at which the conductive metal particles included in the conductive paste films to be the inner electrodes sinter is lower than the temperature at which the ceramic material that forms the dielectric layers sinters, which means that the metal particles included in the inner electrodes sinter first. This causes a reduced coverage of the inner electrodes. In particular, inner electrodes formed as thin layers, for example, reduced to a thickness of less than 1.0 μm, are likely to have a low coverage. With such inner electrodes, there is a disadvantage that such a low coverage often prevents increasing the capacitance.

To form thin-layer inner electrodes with a high coverage, therefore, it is necessary to increase the temperature at which the conductive metal particles included in the conductive paste films to be the inner electrodes sinter in the firing step during the manufacture of the multilayer ceramic capacitor. Through this, the temperature at which the metal particles included in the conductive paste films to be the inner electrodes sinter can be brought closer to the temperature at which the ceramic that forms the dielectric layers starts sintering, and thus the onset of shrinkage during sintering can be made closer between the inner electrodes and the dielectric layers. As a result, the coverage of the inner electrodes increases, allowing a large capacitance to be achieved.

As a way to increase the coverage of the inner electrodes and achieve a large capacitance by the method described above, it is known to add a ceramic material having a composition similar to the composition of the ceramic material that forms the dielectric layers, or, in other words, a common material, to the conductive paste for the formation of the inner electrodes, for example, as described in paragraph 0004 of Japanese Unexamined Patent Application Publication No. 2016-31807. By adding a common material, the onset of sintering of the metal particles included in the conductive paste films to be the inner electrodes can be shifted toward higher temperatures, and thus the temperature at which the metal particles included in the conductive paste films sinter can be brought closer to the temperature at which the ceramic material that forms the dielectric layers sinters.

However, even after the addition of a common material to the conductive paste for the formation of inner electrodes, the temperature at which the metal particles included in the conductive paste sinter remains lower than the temperature at which the ceramic material that forms the dielectric layers sinters. Thus, there is a need for further improvement. In particular, for inner electrodes formed as thin layers, for example, reduced to a thickness of less than 1.0 μm, there is a necessity for an effective solution to the issue of a reduced coverage, which prevents increasing the capacitance.

### SUMMARY OF THE INVENTION

Example embodiments of the present invention provide multilayer ceramic capacitors that each include inner electrodes that maintain a relatively high coverage even when provided as thin layers.

A multilayer ceramic capacitor according to an example embodiment of the present invention includes a multilayer body including multiple ceramic dielectric layers stacked together and multiple inner electrodes along multiple interfaces between the dielectric layers, with each inner electrode along a respective interface. The inner electrodes include a conductive component including X and a ceramic component including XTiO₃, where X represents a conductive metal or an alloy including the conductive metal.

According to example embodiments of the present invention, a ceramic component including XTiO₃, which includes a same X as an X included in the inner electrodes as a conductive component, is included in the inner electrodes. Through this, the coverage of the inner electrodes is increased. Even when the inner electrodes are provided as thin layers, therefore, the coverage of the inner electrodes does not decrease, and efforts to increase the capacitance of the multilayer ceramic capacitor are not hindered.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a cross-sectional view schematically illustrating a multilayer ceramic capacitor 1 according to an example embodiment of the present invention.

### DETAILED DESCRIPTION OF THE EXAMPLE EMBODIMENTS

Example embodiments of the present invention are described in detail below with reference to the drawings.

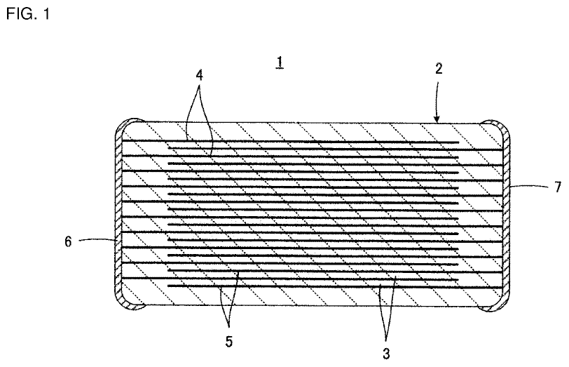

With reference to FIG. 1, the structure of a multilayer ceramic capacitor 1 according to an example embodiment of the present invention will be described.

The multilayer ceramic capacitor 1 includes a multilayer body 2. The multilayer body 2 includes multiple ceramic dielectric layers 3 stacked together and multiple inner electrodes 4 and 5 arranged along the interfaces between the multiple dielectric layers 3. The inner electrodes 4 and 5 include multiple first inner electrodes 4 and multiple second inner electrodes 5 arranged alternately in the direction of stacking in the multilayer body 2. At the outer surface of the multilayer body 2, or more specifically the end surfaces facing each other, a first outer electrode 6 and a second outer electrode 7 are provided, with each outer electrode at a respective end surface. The first outer electrode 6 is electrically coupled to the first inner electrodes 4, and the second outer electrode 7 is electrically coupled to the second inner electrodes 5.

The dielectric layers 3 are made of a ceramic material that includes, for example, ABO₃ (A is at least one of Ba, Ca, or Sr, and B is at least one of Ti or Zr) as a base component. The ceramic material, furthermore, may include the ABO₃ as a base component and further include at least one of Mn, Mg, Si, Y, Dy, or Gd as a minor component. In experimental examples described later, the dielectric layers 3 are made of a ceramic material that includes at least one of BaTiO₃, SrTiO₃, or CaZrO₃ as a base component.

The inner electrodes 4 and 5 preferably include, as a conductive component, a conductive metal or an alloy including a conductive metal, such as one of nickel, copper, silver, or a silver/palladium alloy, for example. As a characteristic composition, for example, furthermore, the inner electrodes 4 and 5 include a ceramic component including XTiO₃, where X represents the conductive metal or alloy including the conductive metal that is the conductive component. The ceramic component including XTiO₃ preferably has an ilmenite crystal structure, for example. As can be seen from the experimental examples described later, the inner electrodes 4 and 5 may further include, as a ceramic component, at least one of BaTiO₃, SrTiO₃, or CaZrO₃ included in the dielectric layers 3.

The percentage of the ceramic component in the inner electrodes 4 and 5 is, for example, preferably about 5% by mass or more and about 15% by mass or less. The percentage refers to {(the mass of the ceramic component)/(the mass of the ceramic component+the mass of the conductive metal or the alloy including it)}×100 (the same applies hereinafter).

The outer electrodes 6 and 7 are formed by, for example, applying a conductive paste in which Ag or Cu is the base ingredient in the conductive component to the end surfaces of the multilayer body 2 and baking the applied paste. Optionally, the thick films formed through baking may be coated with, for example, Ni plating and Sn plating.

The multilayer ceramic capacitor 1 is manufactured through, for example, steps such as the following. First, a ceramic slurry including ceramic raw material powders that will provide a composition as described above is produced. Then ceramic green sheets are shaped by applying an appropriate sheet shaping method to the ceramic slurry. Then a conductive paste to form each of the inner electrodes 4 and 5 is applied onto predetermined ones of the multiple ceramic green sheets, for example by printing. Then the multiple ceramic green sheets are stacked and then pressure-bonded to form a raw multilayer body. Then the raw multilayer body is fired. Through this step of firing, the ceramic green sheets turn into the dielectric layers 3. Thereafter, the outer electrodes 6 and 7 are formed at the end surfaces of the multilayer body 2.

The conductive paste to form the inner electrodes 4 and 5 used during the manufacture of the multilayer ceramic capacitor 1 described above is preferably produced as follows, for example.

In the production of the conductive paste, a first step, in which a ceramic powder slurry including a ceramic powder, an organic solvent, and a dispersant is prepared, a second step, in which a metal powder slurry including a conductive metal powder, an organic solvent, and a dispersant is prepared, a third step, in which an organic vehicle including an organic resin component and an organic solvent is prepared, and a fourth step, in which the ceramic powder slurry, the metal powder slurry, and the organic vehicle are mixed, are carried out.

To be more specific, in the first step, a ceramic powder slurry is prepared by mixing a ceramic powder and a dispersant into an organic solvent.

The ceramic powder is changed depending on the type of conductive metal or alloy of the conductive metal powder included in the metal powder slurry prepared in the second step, which will be described later. That is, a powder made of XTiO₃, where X represents the conductive metal or alloy of the conductive metal powder, is selected as the ceramic powder to be included in the ceramic powder slurry. In addition to this powder, the ceramic powder slurry may optionally be formulated to include a powder made of, for example, at least one of BaTiO₃, SrTiO₃, or CaZrO₃ as a common material.

With a ceramic powder made of XTiO₃, the reaction that can occur between it and the powder made of X included in the metal powder slurry, which will be prepared in the second step, during firing can be reduced. The ceramic powder may include the XTiO₃ as a base component and further include at least one of Mn, Mg, Si, Y, Dy, or Gd as a minor component. When the ceramic powder includes such a minor component, the sintering of the metal particles may be effectively reduced or prevented as a result of further controlled growth of ceramic particles.

The dispersant mixed into the ceramic powder in the first step can be, for example, an anionic polymer dispersant. The organic solvent can be, for example, dihydroterpineol.

In the second step, a metal powder slurry is prepared by mixing a conductive metal powder and a dispersant into an organic solvent. The conductive metal powder is, for example, a powder made of one of nickel, copper, silver, or a silver/palladium alloy. A dispersant and an organic solvent that can be used in the second step are the same as in the first step.

In the third step, an organic vehicle is prepared by mixing an organic resin component into an organic solvent. The organic resin component can be, for example, an ethyl cellulose resin. An organic solvent that can be used in the third step is also the same as in the first step.

In the fourth step, the ceramic powder slurry, the metal powder slurry, and the organic vehicle described above are mixed. Through this, a conductive paste to form the inner electrodes 4 and 5 is obtained. This conductive paste includes a ceramic powder slurry, and, as stated above, the ceramic powder slurry includes a ceramic powder made of XTiO₃. The inner electrodes 4 and 5 included in the multilayer ceramic capacitor 1 manufactured through a firing step, therefore, will include a ceramic component including XTiO₃.

The percentage of the ceramic powder in the conductive paste is, for example, preferably about 5% by mass or more and about 15% by mass or less.

Experimental examples conducted to determine the scope of the present invention and verify advantages provided by the present invention will now be described.

### EXPERIMENTAL EXAMPLE 1

In Experimental Example 1, as specified in Table 1, the conductive component and ceramic components included in the inner electrodes were changed, while the base component of the ceramic material of the dielectric layers was fixed as BaTiO₃.

### 1-1. Preparation of a BaTiO₃ Ceramic Raw Material of the Dielectric Layers

As starting materials, powders of BaCO₃ and TiO₂, which were base ingredients, were weighed out and mixed for about 72 hours using a ball mill. Then the resulting mixture was subjected to heat treatment for about 2 hours with the maximum temperature of about 1000° C., yielding a thermally treated powder. Separately, as minor ingredients, powders of MnO, Dy₂O₃, MgO, SiO₂, and BaCO₃ were prepared and weighed out such that the proportions of the minor ingredient powders to the thermally treated powder were 100BaTiO₃+about 0.5Mn+about 1.0Dy+about 1.0 Mg+about 1.0Si+about 2.0Ba. These minor ingredient powders were added to the thermally treated powder, the powders were mixed for about 24 hours using a ball mill, and then the resulting mixture was dried. In this manner, a BaTiO₃ ceramic raw material powder was obtained.

### 1-2. Preparation of a Conductive Paste for the Formation of Inner Electrodes

As the conductive component to be included in the inner electrodes, a powder made of Ni, Cu, Ag, or a Ag—Pd alloy, as specified in the “Conductive Component” section under “Inner Electrodes” in Table 1, was prepared. The Ag—Pd alloy was, more specifically, a 0.7Ag—0.3Pd alloy.

Separately, as the ceramic component including XTiO₃ to be included in the inner electrodes, a ceramic powder made of NiTiO₃, CuTiO₃, AgTiO₃, or (Ag, Pd)TiO₃, as specified in the “Ceramic Components” section under “Inner Electrodes” in Table 1, was prepared. The (Ag,Pd)TiO₃ was, more specifically, (Ag0.7Pd0.3)TiO₃.

In addition, as another ceramic component to be included in the inner electrodes, a BaTiO₃ ceramic powder, which was a common material for the ceramic material of the dielectric layers, was also prepared as specified in the “Ceramic Components” section under “Inner Electrodes” in Table 1.

These ceramic powders including XTiO₃ and BaTiO₃ ceramic powder were weighed out to the percentages in % by volume specified in the “Ceramic Components” section in Table 1. These powders and dihydroterpineol as an organic solvent and an anionic polymer dispersant as a dispersant were preliminarily mixed in a stirring mill without a medium and then subjected to dispersion treatment in a medium stirring mill. In this manner, a ceramic powder slurry was prepared (first step).

Separately, a metal powder slurry was prepared by subjecting the powder made of Ni, Cu, Ag, or an Ag—Pd alloy, as specified in the “Conductive Component” section under “Inner Electrodes” in Table 1, dihydroterpineol as an organic solvent, and an anionic polymer dispersant as a dispersant to dispersion treatment in a three-roll mill (second step).

An organic vehicle, furthermore, was obtained by mixing an ethyl cellulose resin as an organic resin component with dihydroterpineol, which is an organic solvent (third step).

Thereafter, the metal powder slurry and the ceramic powder slurry were added to the organic vehicle, and mixing and dispersion treatment was performed. In this manner, a conductive paste for the formation of inner electrodes was prepared (fourth step).

Here, the percentage of ceramic powder in the conductive paste for the formation of inner electrodes was set to about 10% by mass.

### 1-3. Production of a Multilayer Ceramic Capacitor

A ceramic slurry including the BaTiO₃ ceramic raw material powder prepared in 1-1 above was prepared, and then ceramic green sheets were shaped by applying doctor blading to the ceramic slurry. Then the conductive paste for the formation of inner electrodes prepared in 1-2 above was applied onto predetermined ones of the multiple ceramic green sheets by screen printing. Then the multiple ceramic green sheets were stacked and then pressure-bonded to give a raw multilayer body. Then the raw multilayer body was fired. Thereafter, outer electrodes were formed at the end surfaces of the sintered multilayer body. In this manner, a sample multilayer ceramic capacitor was produced.

### 1-4. Evaluation

TABLE 1

| | | Inner Electrodes | | | | |
|---|---|---|---|---|---|---|
| Sample | Dielectric | Conductive | Ceramic | (% by | | |
| Number | Layers | Component | Components | volume) | Coverage [%] | Assessment |
| 1 | BaTiO₃ | Ni | NiTiO₃ | (100) | 85 | ∘ |
| | | | BaTiO₃ | (0) | | |
| 2 | | | NiTiO₃3 | (10) | 85 | ∘ |
| | | | BaTiO₃ | (90) | | |
| 3 | | | NiTiO₃ | (0) | 74 | x |
| | | | BaTiO₃ | (100) | | |
| 4 | | Cu | CuTiO₃ | (100) | 85 | ∘ |
| | | | BaTiO₃ | (0) | | |
| 5 | | | CuTiO₃ | (10) | 85 | ∘ |
| | | | BaTiO₃ | (90) | | |
| 6 | | | CuTiO₃ | (0) | 74 | x |
| | | | BaTiO₃ | (100) | | |
| 7 | | Ag | AgTiO₃ | (100) | 85 | ∘ |
| | | | BaTiO₃ | (0) | | |
| 8 | | | AgTiO₃ | (10) | 83 | ∘ |
| | | | BaTiO₃ | (90) | | |
| 9 | | | AgTiO₃ | (0) | 75 | x |
| | | | BaTiO₃ | (100) | | |
| 10 | | Ag—Pd | (Ag, Pd)TiO₃ | (100) | 85 | ∘ |
| | | | BaTiO₃ | (0) | | |
| 11 | | | (Ag, Pd)TiO₃ | (10) | 83 | ∘ |
| | | | BaTiO₃ | (90) | | |
| 12 | | | (Ag, Pd)TiO₃ | (0) | 75 | x |
| | | | BaTiO₃ | (100) | | |

An inner electrode and a dielectric layer located in the middle portion, in the height direction, of the multilayer body included in the sample multilayer ceramic capacitor were torn apart from each other by electric field separation.

Then the vicinity of the middle portion (the position at about ½ in the width direction and about ½ in the length direction) of the exposed inner electrode was observed using a microscope at a magnification of about 100×. By analyzing the obtained image, the percentage of the area that the conductive film as an inner electrode occupied in the exposed portion was determined as the “coverage” presented in Table 1. Samples with a “coverage” of more than about 80% were determined to be good, and “o” was recorded in the “Assessment” section. Samples with a “coverage” of about 80% or less were determined to be poor, and “x” was recorded in the “Assessment” section.

### 1-5. Discussion

Samples 1, 2, 4, 5, 7, 8, 10, 11 in Table 1 received an “assessment” of “o.” For these samples 1, 2, 4, 5, 7, 8, 10, and 11, the inner electrodes include a conductive component composed of X and a ceramic component composed of XTiO₃.

For samples 1, 2, 4, 5, 7, 8, 10, and 11, the XTiO₃ that was a ceramic component in the inner electrodes included the same X as the conductive component in the inner electrodes. Presumably as a result of this, the conductive component included in the inner electrodes remained in the inner electrode portion rather than being expelled, acting to improve the heat resistance of the inner electrodes, resulting in a high coverage of about 83% or more.

As can be seen from samples 2, 5, 8, and 11, furthermore, the percentage of XTiO₃ in the ceramic components in the inner electrodes is not necessarily 100%, as long as the percentage was about 10% or more, the advantage of improved coverage was observed compared with when no XTiO₃ was included. In addition, the coverages of samples 2 and 5, in which the percentage of XTiO₃ is about 10%, have values equal or substantially equal to the coverages of samples 1 and 4, in which the percentage of XTiO₃ is 100%.

In contrast to these, for samples 3, 6, 9, and 12, which were rated “x,” the inner electrodes included no XTiOs as a ceramic component. Samples 3, 6, 9, and 12 included only a BaTiO₃ ceramic material as a common material for the ceramic material of the dielectric layers. As a result, the coverage was as low as about 75% or less.

For these samples 3, 6, 9, and 12, BaTiO₃ was expelled from the inner electrode portion. Presumably, as a result of this, the heat resistance of the inner electrodes was not improved, and the coverage was low.

### EXPERIMENTAL EXAMPLE 2

In Experimental Example 2, as specified in Table 2, the conductive component and ceramic components included in the inner electrodes were changed, while the base component of the ceramic material of the dielectric layers was fixed as CaZrO₃.

### 2-1. Preparation of a CaZrO₃ Ceramic Raw Material of the Dielectric Layers

As starting materials, powders of CaCO₃ and ZrO₂, which were base ingredients, and powders of MnO, SiO₂, and MgO, which were minor ingredients, were weighed out and mixed for about 72 hours using a ball mill. Then the resulting mixture was subjected to heat treatment for about 2 hours, with the maximum temperature being about 1000° C. In this manner, a CaZrO₃ ceramic raw material powder was obtained.

### 2-2. Preparation of a Conductive Paste for the Formation of Inner Electrodes

As in the case of Experimental Example 1, a powder made of Ni, Cu, Ag, or a Ag—Pd alloy, as specified in the “Conductive Component” section under 1 “Inner Electrodes” in Table 2, was prepared as the conductive component to be included in the inner electrodes. The Ag—Pd alloy was, more specifically, a 0.7Ag—0.3Pd alloy.

Separately, as the ceramic component including XTiO₃ to be included in the inner electrodes, a ceramic powder made of NiTiO₃, CuTiO₃, AgTiO₃, or (Ag, Pd) TiO₃, as specified in the “Ceramic Components” section under “Inner Electrodes” in Table 2, was prepared. The (Ag,Pd)TiO₃ was, more specifically, (Ag0.7Pd0.3)TiO₃.

In addition, as another ceramic component to be included in the inner electrodes, a CaZrO₃ ceramic powder, which was a common material for the ceramic material of the dielectric layers, was also prepared as specified in the “Ceramic Components” section under “Inner Electrodes” in Table 2.

These ceramic powder including XTiO₃ and CaZrO₃ ceramic powder were weighed out to the percentages in % by volume specified in the “Ceramic Components” section in Table 2. These powders and dihydroterpineol as an organic solvent and an anionic polymer dispersant as a dispersant were preliminarily mixed in a stirring mill without a medium and then subjected to dispersion treatment in a medium stirring mill. In this manner, a ceramic powder slurry was prepared (first step).

Separately, a metal powder slurry was prepared by subjecting the powder made of Ni, Cu, Ag, or an Ag—Pd alloy, as specified in the “Conductive Component” section under “Inner Electrodes” in Table 2, dihydroterpineol as an organic solvent, and an anionic polymer dispersant as a dispersant to dispersion treatment in a three-roll mill (second step).

An organic vehicle, furthermore, was obtained by mixing an ethyl cellulose resin as an organic resin component with dihydroterpineol, which is an organic solvent (third step).

Thereafter, the metal powder slurry and the ceramic powder slurry were added to the organic vehicle, and mixing and dispersion treatment was performed. In this manner, a conductive paste for the formation of inner electrodes was prepared (fourth step).

Here, the percentage of ceramic powder in the conductive paste for the formation of inner electrodes was set to about 10% by mass.

### 2-3. Production of a Multilayer Ceramic Capacitor

A ceramic slurry including the CaZrO₃ ceramic raw material powder prepared in 2-1 above was prepared, and then ceramic green sheets were shaped by applying doctor blading to the ceramic slurry. Then the same steps as in the case of Experimental Example 1 were followed to produce a sample multilayer ceramic capacitor.

### 2-4. Evaluation

TABLE 2

| | | Inner Electrodes | | | | |
|---|---|---|---|---|---|---|
| Sample | Dielectric | Conductive | Ceramic | (% by | | |
| Number | Layers | Component | Components | volume) | Coverage [%] | Assessment |
| 21 | CaZrO₃ | Ni | NiTiO₃ | (100) | 84 | ∘ |
| | | | CaZrO₃ | (0) | | |
| 22 | | | NiTiO₃ | (10) | 83 | ∘ |
| | | | CaZrO₃ | (90) | | |
| 23 | | | NiTiO₃ | (0) | 72 | x |
| | | | CaZrO₃ | (100) | | |
| 24 | | Cu | CuTiO₃ | (100) | 84 | ∘ |
| | | | CaZrO₃ | (0) | | |
| 25 | | | CuTiO₃ | (10) | 83 | ∘ |
| | | | CaZrO₃ | (90) | | |
| 26 | | | CuTiO₃ | (0) | 72 | x |
| | | | CaZrO₃ | (100) | | |
| 27 | | Ag | AgTiO₃ | (100) | 84 | ∘ |
| | | | CaZrO₃ | (0) | | |
| 28 | | | AgTiO₃ | (10) | 83 | ∘ |
| | | | CaZrO₃ | (90) | | |
| 29 | | | AgTiO₃ | (0) | 72 | x |
| | | | CaZrO₃ | (100) | | |
| 30 | | Ag—Pd | (Ag, Pd)TiO₃ | (100) | 84 | ∘ |
| | | | CaZrO₃ | (0) | | |
| 31 | | | (Ag, Pd)TiO₃ | (10) | 83 | ∘ |
| | | | CaZrO₃ | (90) | | |
| 32 | | | (Ag, Pd)TiO₃ | (0) | 72 | x |
| | | | CaZrO₃ | (100) | | |

The “coverage” was determined as presented in Table 2 following the same procedure as in the case of Experimental Example 1 and evaluated as in Experimental Example 1.

### 2-5. Discussion

Samples 21, 22, 24, 25, 27, 28, 30, and 31 in Table 2 received an “assessment” of “o.” For these samples 21, 22, 24, 25, 27, 28, 30, and 31, the inner electrodes include a conductive component including X and a ceramic component including XTiO₃.

For samples 21, 22, 24, 25, 27, 28, 30, and 31, the XTiO₃ that was a ceramic component in the inner electrodes included the same X as the conductive component in the inner electrodes. Presumably, as a result of this, the conductive component included in the inner electrodes remained in the inner electrode portion rather than being expelled, acting to improve the heat resistance of the inner electrodes, resulting in a high coverage of about 83% or more.

As can be seen from samples 22, 25, 28, and 31, furthermore, the percentage of XTiO₃ in the ceramic components in the inner electrodes is not necessarily 100%, as long as the percentage was about 10% or more, the advantage of improved coverage was observed compared with when no XTiO₃ was included.

In contrast to these, for samples 23, 26, 29, and 32, which were rated “x,” the inner electrodes included no XTiOs as a ceramic component. They included only a CaZrO₃ ceramic material as a common material for the ceramic material of the dielectric layers. As a result, the coverage was as low as about 72%.

For these samples 23, 26, 29, and 32, CaZrO₃ was expelled from the inner electrode portion. Presumably, as a result of this, the heat resistance of the inner electrodes was not improved, and the coverage was low.

### EXPERIMENTAL EXAMPLE 3

In Experimental Example 3, as specified in Table 3, the conductive component and ceramic components included in the inner electrodes were changed, while the base component of the ceramic material of the dielectric layers was fixed as SrTiO₃.

### 3-1. Preparation of a SrTiO₃ Ceramic Raw Material of the Dielectric Layers

As starting materials, powders of SrCO₃ and TiO₂, which were base ingredients, and powders of Mno, SiO₂, and MgO, which were minor ingredients, were weighed out and mixed for about 72 hours using a ball mill. Then the resulting mixture was subjected to heat treatment for about 2 hours, with the maximum temperature being about 1000° C. In this manner, a SrTiOs ceramic raw material powder was obtained.

### 3-2. Preparation of a Conductive Paste for the Formation of Inner Electrodes

As in the case of Experimental Example 1, a powder made of Ni, Cu, Ag, or a Ag—Pd alloy, as specified in the “Conductive Component” section under “Inner Electrodes” in Table 3, was prepared as the conductive component to be included in the inner electrodes. The Ag—Pd alloy was, more specifically, a 0.7Ag-0.3Pd alloy.

Separately, as the ceramic component including XTiO₃ to be included in the inner electrodes, a ceramic powder made of NiTiO₃, CuTiO₃, AgTiO₃, or (Ag,Pd)TiO₃, as specified in the “Ceramic Components” section under “Inner Electrodes” in Table 3, was prepared. The (Ag,Pd)TiO₃ was, more specifically, (Ag0.7Pd0.3)TiO₃.

In addition, as another ceramic component to be included in the inner electrodes, a SrTiO₃ ceramic powder, as a common material for the ceramic material of the dielectric layers, was also prepared as specified in the “Ceramic Components” section under “Inner Electrodes” in Table 3.

These ceramic powders including XTiO₃ and SrTiO₃ ceramic powder were weighed out to the percentages in % by volume specified in the “Ceramic Components” section in Table 3. These powders and dihydroterpineol as an organic solvent and an anionic polymer dispersant as a dispersant were preliminarily mixed in a stirring mill without a medium and then subjected to dispersion treatment in a medium stirring mill. In this manner, a ceramic powder slurry was prepared (first step).

Separately, a metal powder prepared by subjecting the powder made of Ni, Cu, Ag, or an Ag—Pd alloy, as specified in the “Conductive Component” section under “Inner Electrodes” in Table 3, dihydroterpineol as an organic solvent, and an anionic polymer dispersant as a dispersant to dispersion treatment in a three-roll mill (second step).

An organic vehicle, furthermore, was obtained by mixing an ethyl cellulose resin as an organic resin component with dihydroterpineol, which is an organic solvent (third step).

Thereafter, the metal powder slurry and the ceramic powder slurry were added to the organic vehicle, and mixing and dispersion treatment was performed. In this manner, a conductive paste for the formation of inner electrodes was prepared (fourth step).

Here, the percentage of ceramic powder in the conductive paste for the formation of inner electrodes was set to about 10% by mass.

### 3-3. Production of a Multilayer Ceramic Capacitor

A ceramic slurry including the SrTiO₃ ceramic raw material powder prepared in 3-1 above was prepared, and then ceramic green sheets were shaped by applying doctor blading to the ceramic slurry. Then the same steps as in the case of Experimental Example 1 were followed to produce a sample multilayer ceramic capacitor.

### 3-4. Evaluation

TABLE 3

| | | Inner Electrodes | | | | |
|---|---|---|---|---|---|---|
| Sample | Dielectric | Conductive | Ceramic | (% by | | |
| Number | Layers | Component | Components | volume) | Coverage [%] | Assessment |
| 41 | SrTiO₃ | Ni | NiTiO₃ | (100) | 83 | ∘ |
| | | | SrTiO₃ | (0) | | |
| 42 | | | NiTiO₃ | (10) | 82 | ∘ |
| | | | SrTiO₃ | (90) | | |
| 43 | | | NiTiO₃ | (0) | 70 | x |
| | | | SrTiO₃ | (100) | | |
| 44 | | Cu | CuTiO₃ | (100) | 83 | ∘ |
| | | | SrTiO₃ | (0) | | |
| 45 | | | CuTiO₃ | (10) | 82 | ∘ |
| | | | SrTiO₃ | (90) | | |
| 46 | | | CuTiO₃ | (0) | 70 | x |
| | | | SrTiO₃ | (100) | | |
| 47 | | Ag | AgTiO₃ | (100) | 83 | ∘ |
| | | | SrTiO₃ | (0) | | |
| 48 | | | AgTiO₃ | (10) | 82 | ∘ |
| | | | SrTiO₃ | (90) | | |
| 49 | | | AgTiO₃ | (0) | 70 | x |
| | | | SrTiO₃ | (100) | | |
| 50 | | Ag—Pd | (Ag, Pd)TiO₃ | (100) | 83 | ∘ |
| | | | SrTiO₃ | (0) | | |
| 51 | | | (Ag, Pd)TiO₃ | (10) | 82 | ∘ |
| | | | SrTiO₃ | (90) | | |
| 52 | | | (Ag, Pd)TiO₃ | (0) | 70 | x |
| | | | SrTiO₃ | (100) | | |

The “coverage” was determined as presented in Table 3 following the same procedure as in the case of Experimental Example 1 and evaluated as in Experimental Example 1.

### 3-5. Discussion

Samples 41, 42, 44, 45, 47, 48, 50, and 51 in Table 3 received an “assessment” of “o.” For these samples 41, 42, 44, 45, 47, 48, 50, and 51, the inner electrodes include a conductive component including X and a ceramic component including XTiO₃.

For samples 41, 42, 44, 45, 47, 48, 50, and 51, the XTiO₃ that was a ceramic component in the inner electrodes included the same X as the conductive component in the inner electrodes. Presumably, as a result of this, the conductive component included in the inner electrodes remained in the inner electrode portion rather than being expelled, acting to improve the heat resistance of the inner electrodes, resulting in a high coverage of about 82% or more.

As can be seen from samples 42, 45, 48, and 51, furthermore, the percentage of XTiO₃ in the ceramic components in the inner electrodes is not necessarily 100%, as long as the percentage was about 10% or more, the advantage of improved coverage was observed compared with when no XTiO₃ was included.

In contrast to these, for samples 43, 46, 49, and 52, which were rated “x,” the inner electrodes included no XTiO₃ as a ceramic component. They included only a SrTiO₃ ceramic material as a common material for the ceramic material of the dielectric layers. As a result, the coverage was as low as about 70%.

For these samples 43, 46, 49, and 52, SrTiO₃ was expelled from the inner electrode portion. Presumably, as a result of this, the heat resistance of the inner electrodes was not improved, and the coverage was low.

In the experimental examples described above, for example, nickel, copper, silver, or a silver/palladium alloy were selected as conductive components included in the inner electrodes. Other conductive metals or their alloys, however, may be selected.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of ceramic dielectric layers stacked together and a plurality of inner electrodes extending along a plurality of interfaces between the plurality of dielectric layers, wherein
the plurality of inner electrodes include a conductive component including X and a ceramic component including XTiO₃, where X represents a conductive metal or an alloy including a conductive metal.

2. The multilayer ceramic capacitor according to claim 1, wherein the ceramic component including XTiO₃ has an ilmenite crystal structure.

3. The multilayer ceramic capacitor according to claim 1, wherein the plurality of inner electrodes have a thickness of less than about 1.0 μm.

4. The multilayer ceramic capacitor according to claim 1, wherein the plurality of inner electrodes have a coverage of more than about 80%.

5. The multilayer ceramic capacitor according to claim 1, wherein the X is one of nickel, copper, silver, or a silver/palladium alloy.

6. The multilayer ceramic capacitor according to claim 1, further comprising a first outer electrode on a first end surface of the multilayer body, and a second outer electrode on a second end surface of the multilayer body.

7. The multilayer ceramic capacitor according to claim 1, wherein the plurality of dielectric layers includes ABO₃, where A includes at least one of Ba, Ca, or Sr, and B includes at least one of Ti or Zr as a base component.

8. The multilayer ceramic capacitor according to claim 1, wherein a percentage of the ceramic component in each of the plurality of inner electrodes is about 5% by mass or more and about 15% by mass or less.

9. The multilayer ceramic capacitor according to claim 6, wherein each of the first and second outer electrodes includes Ag or Cu as a main ingredient.

10. A conductive paste for inner electrodes of a multilayer ceramic capacitor, the conductive paste comprising:
a conductive metal powder, a ceramic powder, an organic solvent, and an organic binder; wherein
the conductive paste includes a conductive component including X and a ceramic component including XTiO₃, where X represents a conductive metal or an alloy including a conductive metal.

11. The conductive paste according to claim 10, wherein the ceramic component including XTiO₃ has an ilmenite crystal structure.

12. The conductive paste according to claim 10, wherein the X is one of nickel, copper, silver, or a silver/palladium alloy.
